(19) United States
(12) Patent Application Publication
(10) Pub. No.: US 2013/0305325 A1
(43) Pub. Date: Nov. 14, 2013

(54) Methods for Thwarting Man-In-The-Middle Authentication Hacking

(71) Applicant: Paul Headley, Hollister, CA (US)

(72) Inventor: Paul Headley, Hollister, CA (US)

(21) Appl. No.: 13/469,568

(22) Filed: May 11, 2012

(51) Int. Cl. H04L 9/32; G06F 21/20

(52) U.S. Cl. 726/5; 726/3

(57) ABSTRACT

Methods for user authentication over unsecured networks are provided. Such methods rely on the user having one or two electronic devices, comprising two unique network addresses, and the methods seek to verify that the two network addresses are linked to geographic locations that are proximate to one another at the time of the authentication. Location information reported from user devices is not employed, rather, third-party resources are queried about each network address. A man-in-the-middle attack is suggested whenever the two geographic locations are not within a reasonable proximity of one another.

### CROSS-REFERENCE TO RELATED APPLICATIONS

This application is related to U.S. patent application Ser. No. 13/211,230 filed Aug. 16, 2011 and entitled “Methods for the Secure Use of One-Time Passwords,” to U.S. patent application Ser. No. 12/119,617 filed May 13, 2008 and entitled “Multi-Channel Multi-Factor Authentication,” now U.S. Pat. No. 8,006,291, and to U.S. patent application Ser. No. 12/137,129 filed Jun. 11, 2008 and entitled “Single-Channel Multi-Factor Authentication,” each of which is incorporated herein by reference.

### BACKGROUND OF THE INVENTION

1. Field of the Invention

The present invention relates generally to the field of authentication and more particularly to securing communications channels over unsecured networks between user-operated computing systems and servers used to authenticate users.

2. Related Art

Unsecured networks such as the Internet are commonly used to connect servers with numerous clients. Typically, when a user of a client computing system seeks to access secure information or protected services from a server, the user has to provide some credential that indicates the user is authorized, whether a password, a one-time password (OTP), image selection, biometrics data or some other form of authentication data. That credential is passed to the authentication server over a communication channel, either a primary channel such as the channel established over the unsecured network between the user's client computing system and the authentication server, or over a secondary channel between the authentication server and the user, such as to the user's cellular device. One particular failing common to all of these authentication systems, however, is that passing credentials over unsecured networks inherently provides opportunities to defeat the system to gain unauthorized access, commonly referred to as hacking.

FIG. 1 serves to illustrate a number of methods used by cybercriminals to defeat authentication systems that employ unsecured networks. In FIG. 1 a user 100 employs a user computing system 110 having access to the Internet 120. The methods used by cybercriminals begin by duping the user 100 into accessing a criminal computing system 130 rather than an intended and legitimate authentication computing system 140. Data served by the computing system 130 provides a login page that closely resembles a login page provided by the authentication computing system 140. A user 100 might inadvertently access the website hosted by the criminal computing system 130 by mistyping the URL for the authentication computing system 140 and instead mistakenly typing an intentionally similar URL that points to the criminal computing system 130. Fraudulent e-mails that closely resemble legitimate e-mails from banks and the like are another means by which users 100 can be duped into following a link to the URL for the criminal computing system 130.

If the user 100 is fooled into believing that the website hosted by the criminal computing system 130 is actually that of the authentication computing system 140, when the user 100 then attempts to login, the user 100 unwittingly provides their login credentials to the criminal computing system 130. In the simplest of authentication systems, such as those that merely require a user ID and password, the computing system 130 can then dispense with the user 100, for example by serving a page indicating that the website is temporarily unavailable. The cybercriminal, termed the “man-in-the-middle,” then has the necessary credentials to gain unauthorized access to the authentication computing system 140.

Some authentication systems employ an OTP for greater security, and in some of these systems the OTP is only valid for a short length of time. Some of these authentication systems require the user 100 to possess a token 150 that generates the OTP when authenticating, where the token 150 is a physical device that is synchronized with the computing system 140, though they do not communicate with each other. For instance, both can employ the same algorithm to generate the OTP using the time and date as a seed. Where the user 100 possesses a token 150, the duped user 100 would provide the OTP as a further credential to the criminal computing system 130. The criminal computing system 130 can then complete the login process with the authentication computing system 140 to gain unauthorized access.

In other authentication systems the authentication computing system 140 responds to the receipt of the credentials from the user 100 by sending an OTP to the user 100 over a second communication channel. For example, as shown in FIG. 1, the authentication computing system 140 would, in response to an authentication attempt that provided a valid user ID, send an OTP in an SMS message to a receiving device 160 previously associated with the user 100. The user 100 then responds by providing the OTP over the original communication channel back to the authentication computing system 140. In a man-in-the-middle attack, the criminal computing system 130 responds to the initially captured credentials by initiating a login attempt with the authentication computing system 140. The authentication computing system 140 sends the OTP to the receiving device 160 and the user 100 reads the OTP and provides the same to the criminal computing system 130 over the original communication channel. The criminal computing system 130 then uses the OTP to complete the authentication.

In those instances where the authentication computing system 140 requires the user 100 to answer a knowledge question or provide a biometric response, the criminal computing system 130 initiates a login with the authentication computing system 140 using the initial credentials from the user 100. The criminal computing system 130 then relays to the user 100 the knowledge question or request for biometrics, using the same format and form as received from the authentication computing system 140. The user 100 enters the knowledge or biometric response which the criminal computing system 130 receives. The criminal computing system 130 then can complete the authentication with the authentication computing system 140.

In still other authentication systems the user 100 completes the authentication over a second channel. With reference again to FIG. 1, the authentication computing system 140 can place a call to the user 100 on the receiving device 160 and ask a knowledge question which the user 100 must answer correctly with the receiving device 160 to complete the authentication. Alternatively, or in addition, the response of the user 100 may be a biometric response that is checked against previously acquired biometrics for the user 100. Regardless of the specifics of the authentication over the second channel, the criminal computing system 130 merely waits until the authentication is completed after which the criminal computing system 130 has access to the authentication computing system 140. As in the previously described methods, the criminal computing system 130 may respond with a misleading response page to the user 100.

### SUMMARY

The present invention provides methods, and systems that implement those methods, for authenticating claimants over unsecured networks. An exemplary method of the invention comprises receiving a claimant target over a first communication channel of an unsecured network, where the first communication channel is identified by a first address, determining a first geographic location of the first address, and verifying that the first geographic location is proximate to a second geographic location of a second address associated with the claimant. In various embodiments receiving the claimant target comprises receiving a user ID or receiving a biometric sample, and in those methods where the claimant target is a biometric sample the method further comprises determining a user ID from the biometric sample.

In various embodiments the first address is an IP address and determining the first geographic location is based on the IP address. In some embodiments, the second address comprises a phone number. In some of these embodiments, verifying that the first geographic location is proximate to the second geographic location comprises using the phone number to query a service provider such as a telecommunications service provider. In some of these further embodiments, verifying that the first geographic location is proximate to the second geographic location further comprises either providing the first geographic location and the phone number to the service provider and receiving a confirmation from the service provider, or providing just the phone number and receiving a second location. In various embodiments verifying that the first geographic location is proximate to the second geographic location can comprise comparing the first geographic location to the second geographic location, or calculating a distance between the first and second geographic locations and comparing that distance to a threshold.

Various embodiments of the method of the invention may further comprise additional authentication steps. For example, the methods can comprise receiving a one-time password over the first or second communication channels, and some of these embodiments further comprise generating the one-time password before receiving the one-time password. Other authentication steps can comprise sending a knowledge question and receiving a response thereto, and/or requesting a biometric sample from the claimant and receiving same in response thereto.

Another exemplary method of the invention is directed to detecting a man-in-the-middle scenario. This method comprises receiving a claimant target over a first communication channel of an unsecured network, the first communication channel being identified by a first address, determining a first geographic location of the first address, and determining that the first address is not proximate to a second address associated with the claimant. In some of these embodiments the method further comprises notifying the claimant that the first communication channel may be compromised. Exemplary systems of the invention comprise logic configured to perform the steps of the exemplary methods described above.

Still another exemplary method of the invention is directed to authenticating a claimant. In this method an authentication computing system receives a claimant target over a first communication channel of an unsecured network, and the first communication channel is identified by a first address, such as an IP address. A second address associated with the claimant is then determined by the authentication computing system, for example, by querying a database using a user ID of the claimant. Next, a query is sent over an out-of-bound communication channel, where the query includes the first and second addresses. For instance, a telecommunication service provider can be given the first and second addresses over the out-of-bound communication channel. The service provider then makes determinations, using the methods described herein, of the geographic locations of the first and second addresses, and a further determination that the geographic locations are proximate to one another. The authentication system then receives verification that geographic locations are proximate.

### BRIEF DESCRIPTION OF DRAWINGS

FIG. 1 is a schematic representation showing how prior art authentication systems employing unsecured networks can be circumvented.

FIG. 2 is a flowchart representation of an authentication method according to an exemplary embodiment of the present invention.

FIG. 3 is a schematic representation of an authentication method according to an exemplary embodiment of the present invention.

### DETAILED DESCRIPTION OF THE INVENTION

The present invention provides methods, and systems that implement those methods, for user authentication over unsecured networks that prevent the aforementioned man-in-the-middle scenarios. The methods of the invention rely on the user possessing either two electronic devices each with a unique address, or one electronic device having a unique address for each of two independent communication networks, and the methods seek to verify that the two addresses can be located within some reasonable proximity to one another at the time of the authentication. Location information that may be reported from the user's device or devices is not employed, rather, third-party sources are queried about each address.

The proximity verification through the third-party sources can be achieved in a number of ways. For example, geographic locations can simply be obtained, based on the two addresses, and then compared. In other embodiments only one geographic location is determined, and a third-party source merely confirms or denies that the second address is associated with a geographic location within a given proximity of the first geographic location. A man-in-the-middle attack is suggested whenever the two geographic locations are not within a reasonable proximity of one another. Methods of the invention can also employ additional authentication steps using either or both of the two devices.

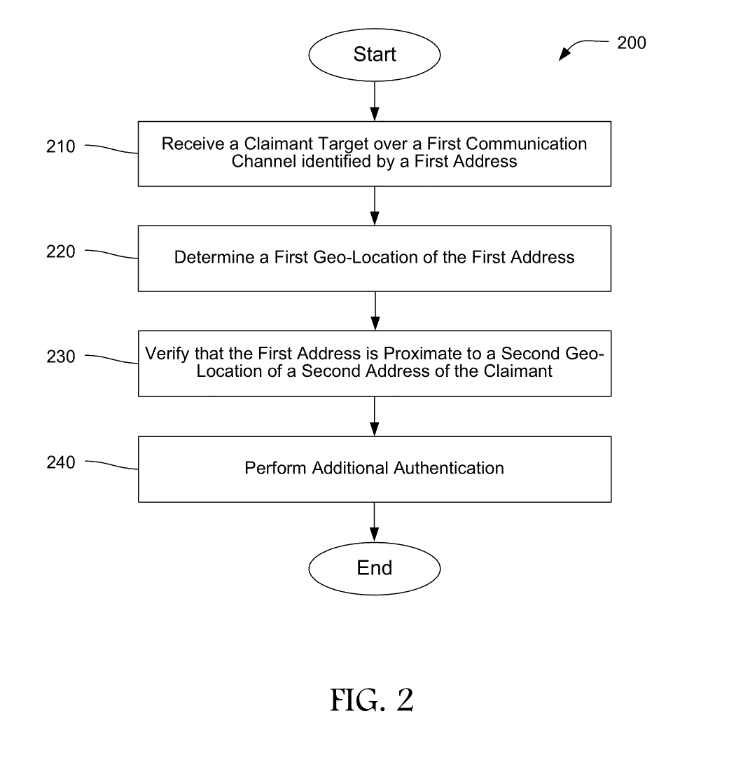

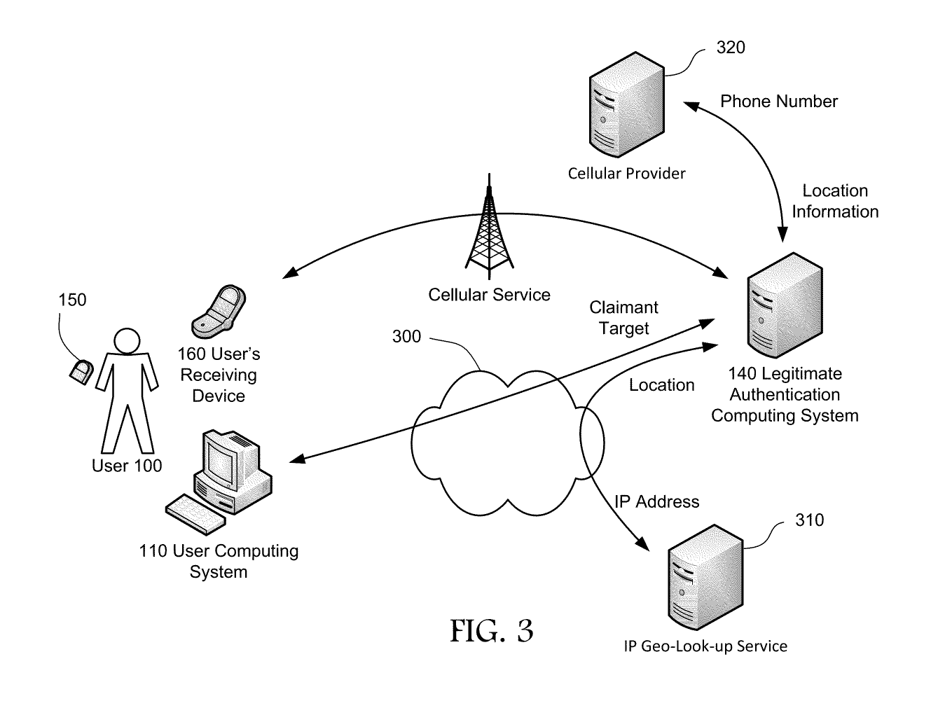

FIG. 2 is a flowchart representation of an exemplary authentication method 200 of the present invention for authenticating a claimant over an unsecured network. FIG. 3 illustrates the exemplary method schematically. With reference to FIG. 3, the method 200 can be performed by an authentication computing system 140, for example, in communication with a user 100. As used herein, a claimant is a person seeking to be authenticated. Here, the user 100 is a claimant to the authentication computing system 140 until authenticated by the method 200.

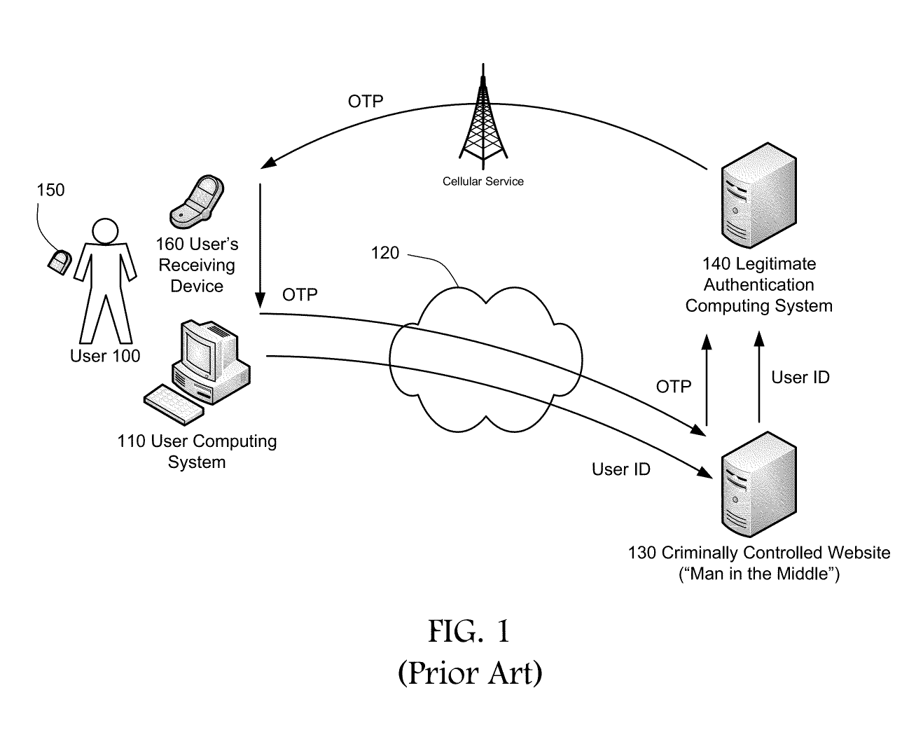

Initially, the user 100 establishes a connection to the authentication computing system 140 over a first communication channel across an unsecured network 300, such as the Internet 120 (FIG. 1), by specifying in a browser of the computing system 110 a URL that points to the authentication computing system 140, for example. In the process of establishing the connection over the first communication channel, the authentication computing system 140 acquires an address of the computing system 110. An address, as used herein, is specifically a unique label assigned to a computing system for participating in a communications network, and examples include Internet Protocol (IP) addresses, phone numbers, and MAC addresses. Specifically excluded from the definition of “address” as used herein are postal addresses, and the like, that may be associated with an owner of a device but do not serve to identify the computing system to the communications network. Where the unsecured network 300 comprises the Internet 120, the first address acquired by the authentication computing system 140 can be the Internet Protocol (IP) address of the computing system 110. Since the first address indicates one end of the first communication channel, the first communication channel is said to be identified by a first address, or alternatively, associated with the first address.

In a step 210 of the method 200, a claimant target is received from a first computing system over the first communication channel of the unsecured network 300. As shown in FIG. 3, the unsecured network 300 can be a Wide Area Network (WAN) such as the Internet 120, and the first computing system can be the user computing system 110, itself essentially any computing system identified by an Internet Protocol address (IP) as exemplified by PCs, laptop computers, tablets, smartphones, and so forth. The claimant target can be a user ID, account number, or some other unique identifier from which the authentication computing system 140 can infer the particular identity sought to be authenticated. In some embodiments the claimant target is a biometric sample such as a fingerprint scan or an image of the user 100. In some embodiments, the authentication computing system 140 uses the claimant target to determine the user ID, such as when the claimant target is a biometric sample.

In a step 220 a geographic location of the first address is determined. While a geographic location can be described as a set of latitude and longitude coordinates or as a street address, the geographic location can also be described as a zip code or as a city, for example. Determining the geographic location of the first address can be based on the IP address of the first computing system. For instance, the IP address 173.16.176.103 is associated with the location Clearlake, Calif. A geographic location for an IP address can be obtained, for example, through on-line resources for IP lookup such as http://www.lookupip.com/ or http://ip-lookup.net, etc. In FIG. 3 this is illustrated by an exchange of an IP address for a geographic location over an out-of-bound communication channel between the authentication computing system 140 and an IP lookup system 310 that provides geo location information. A geographic location for an IP address can also be obtained from the Internet Service Provider (ISP).

In addition to determining the IP address of the first computing system, other information such as the identity of the Internet Service Provider (ISP) for the first computing system and the system signature of the first computing system can optionally be obtained. It will be appreciated that step 220 does not comprise accepting location information from the first computing system since it must be assumed that the first computing system has been compromised such that any location data provided by the first computing system is inherently unreliable.

In a step 230 the proximity of the first geographic location to a second geographic location of a second address associated with the claimant is verified. As used herein, an address is associated with a claimant where the authentication computing system 140 stores a record that links the claimant to the address. For example, where a smartphone is the second computing system, the authentication computing system 140 stores a record that links the claimant's user ID to the phone number of the smartphone. In other words, the stored association between the claimant and the second address, the phone number, allows the authentication computing system 140 to establish the second communication channel to the second computing system upon determination of a user ID in step 210.

Step 230 can be performed in a variety of ways. For example, in some embodiments the second address associated with the claimant comprises another IP address (e.g., the user 100 employs a second user computing system 110). In these embodiments the second IP address is determined as described above. The distance between the first and second locations can be computed and compared to a threshold, where a distance greater than the threshold would suggest a man-in-the-middle situation. In some embodiments a distance calculation is not necessary, for example, where the first and second locations simply match (e.g., both determined locations are Clearlake, Calif.).

In other embodiments the second address associated with the claimant comprises an address of a mobile device such as a phone number. Examples of mobile devices include cellular phones and smartphones and are represented in FIG. 3 by receiving device 160. In some of these embodiments the phone number is used to query a telecommunications service provider 320. For example, the service provider 320 can use the phone number to determine the geographic location of the mobile device through cell tower triangulation or another method that does not rely on the mobile device itself reporting a GPS-derived location. In some cases the service provider 320 can report the location of the second address to the authentication computing system 140 as the second geographic location. Then, the computing system 140 can verify the proximity of the first geographic location to the second geographic location by computing a distance between the locations and comparing the result to a threshold as above.

In other embodiments where the second address is for a mobile device the service provider 320 may not return the second geographic location to the authentication computing system 140 in order to preserve user privacy. In these situations the authentication computing system 140 can provide the phone number of the second computing system and the first location of the first computing system to the service provider 320, the service provider 320 then computes the distance between the locations, and finally reports whether the computed distance is within a threshold. The threshold can be either prearranged or supplied along with the phone number and the first location. As still another alternative, the authentication computing system can provide the first address, such as an IP address, to the service provider 320 instead of the first location and the service provider 320 can determine the two geographic locations and whether they are proximate to each other. As above, if a distance exceeds the threshold, this suggests a man-in-the-middle situation. In various embodiments, a threshold distance between locations that would suggest a man-in-the-middle scenario is 20 miles, 50, miles, 75 miles, 100 miles, 150 miles, or 200 miles.

In an optional step 240 additional authentication using one or both of the first and second computing systems can be pursued for greater security. For example, the authentication computing system 140 can receive an OTP from the user 100 through either the first or second computing systems, and in some of these embodiments the authentication computing system 140 first generates the OTP and transmits the OTP to the user 100. In some of these embodiments, the OTP is sent to the user 100 over one of the first or second communication channels and the user 100 returns the OTP to the authentication computing system 140 over the other of the two channels. Alternatively, the OTP can be produced by a token 150 and sent to the authentication computing system 140 over either of the first or second communication channels.

As another example, authentication computing system 140 can send a knowledge question to the user 100 over one of the first or second channels and the user 100 then returns a response to the authentication computing system 140 either over the same or the other channel. In step 240 the authentication computing system 140 can also receive one or more of a password and a biometric sample from the user 100 over either communication channel. As used herein, a knowledge question asks the user 100 to respond with an answer based on the knowledge of the user 100. For instance, the response can be a prearranged answer to a particular question (e.g., “where were you born?”) or the response can based on personal information (e.g., “what is the sum of the last two digits of your social security number?”).

It will be appreciated that although FIG. 2 represents the steps sequentially, any of the steps following step 210 can be performed in any order, and may overlap in time. Further, if the result of step 230 suggests a man-in-the-middle scenario, the authentication computing system 140 can notify the user 100 over the second channel with an SMS message that the first channel appears to be compromised. Such a notification can report the first geographic location or other information gathered in step 210 based on the first address. Additionally, although FIG. 3 distinguishes between the computing system 110 and the receiving device 160, a single device can be substituted for both where the single device is identified by two addresses, one for each of two independent communication networks.

It will be appreciated that still other methods of the invention do not require the step 220 of determining the first geographic location of the first address. Instead, some methods take the first address identifying the first communication channel, and a second address associated with the claimant, and query the service provider 320 with both addresses. The service provider 320 then determines a geographic location for each address, according to the methods described above, determines whether the geographic locations are proximate, and returns the result. The authentication computing system 140, in these embodiments, receives a verification that the locations are proximate to one another but never knows the actual determined geographic locations.

As used herein, “logic” means as a physical system capable of carrying out a defined series of steps. Logic as used herein can form part of a server, PC, smartphone, tablet computer, and the like and can comprise application-specific integrated circuits (ASICs) specially designed to perform the series of steps, firmware programmed to perform the series of steps, a microprocessor in combination with software stored on a computer-readable medium specifying the series of steps, or any combination of these. It will be understood that logic as used herein specifically excludes software alone. Additionally, “computer-readable medium” as used herein specifically excludes paper and transitory media such as carrier waves.

In the foregoing specification, the invention is described with reference to specific embodiments thereof, but those skilled in the art will recognize that the invention is not limited thereto. Various features and aspects of the above-described invention may be used individually or jointly. Further, the invention can be utilized in any number of environments and applications beyond those described herein without departing from the broader spirit and scope of the specification. The specification and drawings are, accordingly, to be regarded as illustrative rather than restrictive. It will be recognized that the terms “comprising,” “including,” and “having,” as used herein, are specifically intended to be read as open-ended terms of art.

What is claimed is:

1. A method for authenticating a claimant comprising:
receiving a claimant target over a first communication channel of an unsecured network, the first communication channel being identified by a first address;
determining a first geographic location of the first address; and
verifying that the first geographic location is proximate to a second geographic location of a second address associated with the claimant.

2. The method of claim 1 wherein receiving the claimant target comprises receiving a user ID.

3. The method of claim 1 wherein receiving the claimant target comprises receiving a biometric sample and the method further comprises determining a user ID from the biometric sample.

4. The method of claim 1 wherein the first address comprises an IP address and the first location is determined based on the IP address.

5. The method of claim 1 wherein the second address comprises a phone number.

6. The method of claim 5 wherein verifying that the first geographic location is proximate to the second geographic location comprises using the phone number to query a service provider.

7. The method of claim 6 wherein verifying that the first geographic location is proximate to the second geographic location further comprises receiving the second geographic location in response to the query and determining that the second geographic location is within a threshold distance of the first geographic location.

8. The method of claim 6 wherein verifying that the first geographic location is proximate to the second geographic location further comprises providing the first geographic location to the service provider and receiving a confirmation from the service provider.

9. The method of claim 1 further comprising receiving a one-time password over the first communication channel or over a second communication channel identified by the second address.

10. The method of claim 9 further comprising generating the one-time password before receiving the one-time password.

11. The method of claim 1 further comprising sending a knowledge question and receiving a response thereto.

12. The method of claim 1 further comprising requesting a biometric sample from the claimant and receiving same in response thereto.

13. A method for detecting a man-in-the-middle scenario comprising:
receiving a claimant target over a first communication channel of an unsecured network, the first communication channel being identified by a first address;
determining a first geographic location of the first address; and
determining that the first geographic location is not located proximate to a second geographic location of a second address associated with the claimant.

14. The method of claim 13 further comprising notifying the claimant that the first communication channel may be compromised.

15. A system for authenticating a claimant comprising:
logic configured to
receive a claimant target over a first communication channel of an unsecured network, the first communication channel being identified by a first address,
determine a first geographic location of the first address, and
verify that the first geographic location is in proximity to a second geographic location of a second address associated with the claimant.

16. The system of claim 15 wherein the second address comprises a phone number and the logic configured to verify that the first geographic location is proximate to the second geographic location performs the verification step by using the phone number to query a service provider.

17. The system of claim 16 wherein the logic configured to verify that the first address is proximate to the second address further performs the verification step by receiving a second geographic location in response to the query and determining that the second geographic location is within a threshold distance of the first geographic location.

18. The system of claim 16 wherein the logic configured to verify that the first geographic location is proximate to the second geographic location performs the verification step by providing the first geographic location to the service provider and receiving a confirmation from the service provider.

19. A method for authenticating a claimant comprising:
receiving a claimant target over a first communication channel of an unsecured network, the first communication channel being identified by a first address;
determining a second address associated with the claimant;
sending a query including the first and second addresses over an out-of-bound communication channel; and
receiving a verification that geographic locations for the first and second addresses are proximate to one another.
